(19) United States
(12) Patent Application Publication
(10) Pub. No.: US 2012/0168656 A1
(43) Pub. Date: Jul. 5, 2012

(54) SOLENOID SWITCH

(76) Inventors: Pao-Chi CHANG, Shihgang Township (TW); Shu-Mei Liu, Shihgang Township (TW)

(21) Appl. No.: 12/982,147

(22) Filed: Dec. 30, 2010

(51) Int. Cl. F16K 31/02

(52) U.S. Cl. 251/129.15

(57) ABSTRACT

The present invention provides a solenoid switch, which comprising: a valve body, a solenoid valve, a controller and a nozzle; the valve body consists of a valve chamber and a gas inlet/outlet connected with the valve chamber; a first pipe orifice is arranged on the location of the gas outlet connected with the valve chamber; the solenoid valve is arranged on the valve chamber correspondingly with the first pipe orifice, and used to control if the gas outlet is connected with the valve chamber; the controller is extended into the gas inlet, so as to control if gas flows from the gas inlet into the valve chamber; the nozzle is set at one end of the gas outlet.

### BACKGROUND OF INVENTION

1. Field of the Invention

The present invention relates generally to a gas control unit, and more particularly to a solenoid switch.

2. Description of Related Art

The gas refrigerator is utilized in such a way that coolant is heated to flow circularly for refrigeration purpose by taking gas as the fuel. Despite of the fact that gas refrigerator is not widely applied as compared with compressor-based refrigerator, there is still a bigger operating requirement for the gas refrigerator in some occasions, such as: in the open air.

The combustor for the gas refrigerator shall be designed specifically for continuous work in dusty, fibrous and greasy environment. Hence, the gas control valve for the combustor cannot be directly applied to the gas switches of common gas heaters and ovens, as demonstrated by Canada patent No. 2200717, wherein the gas control valve generally comprises: a valve body, manual controller, solenoid valve and tester; of which the valve body is fitted with valve seat and gas outlet/inlet; the manual controller and solenoid valve are arranged correspondingly onto the valve body and mated with the valve seat, so as to control the output of gas from the outlet via the valve seat; the tester is arranged close to the gas outlet of the valve body, and used to guide and check the gas supply.

In view of the compliance of the aforementioned gas control valve with the requirements of gas refrigerator's combustor, the inventor has developed a novel solenoid switch of equivalent functions without departing from the spirit of relevant IPR regulations.

### SUMMARY OF THE INVENTION

The major purpose of the present invention is to provide a solenoid switch that features simple construction and easy assembly compatible with the control requirements of gas refrigerator's combustor.

According to the objective of the present invention, the present invention provides a solenoid switch, which consists of a valve body fitted with a valve chamber as well as a gas inlet and outlet connected with the valve chamber; a first pipe orifice is arranged on the location of the gas outlet connected with the valve chamber; a solenoid valve, arranged on the valve chamber correspondingly with the first pipe orifice, and used to control if the gas outlet is connected with the valve chamber; a controller, arranged at the gas inlet to control if gas flows into the valve chamber; a nozzle, arranged at one end of the gas outlet.

### BRIEF DESCRIPTION OF THE DRAWINGS

The present invention will be more readily understood upon a thoughtful deliberation of the following detailed description of two preferred embodiments of the present invention with reference to the accompanying drawings, wherein:

FIG. 1 is a lateral view of a first preferred embodiment of the present invention;

FIG. 2 is a top side view of the first preferred embodiment of the present invention;

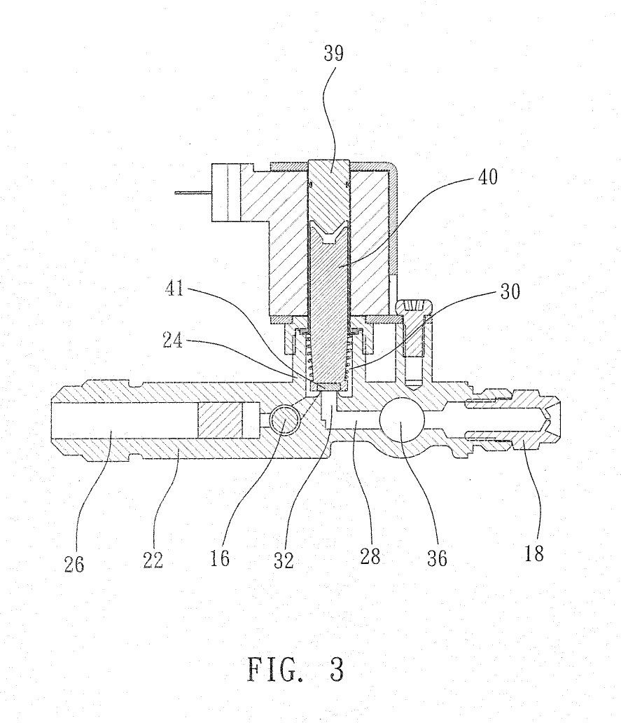

FIG. 3 is a sectional view along the 3-3 line of FIG. 1;

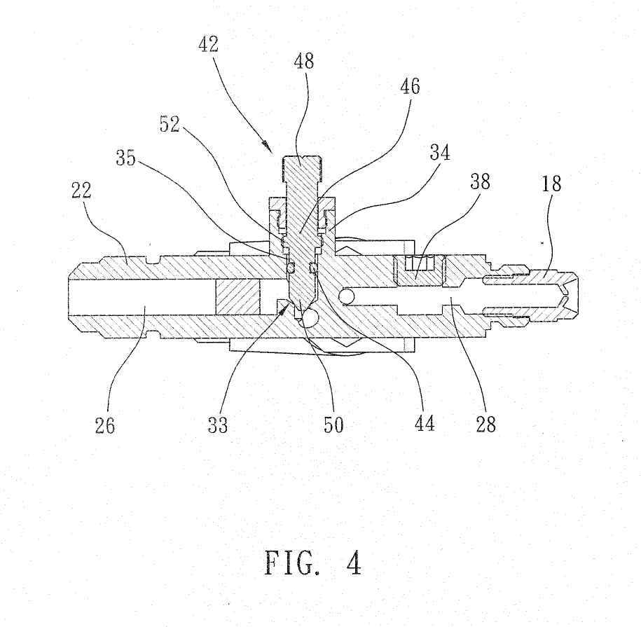

FIG. 4 is a sectional view along the 4-4 line of FIG. 2;

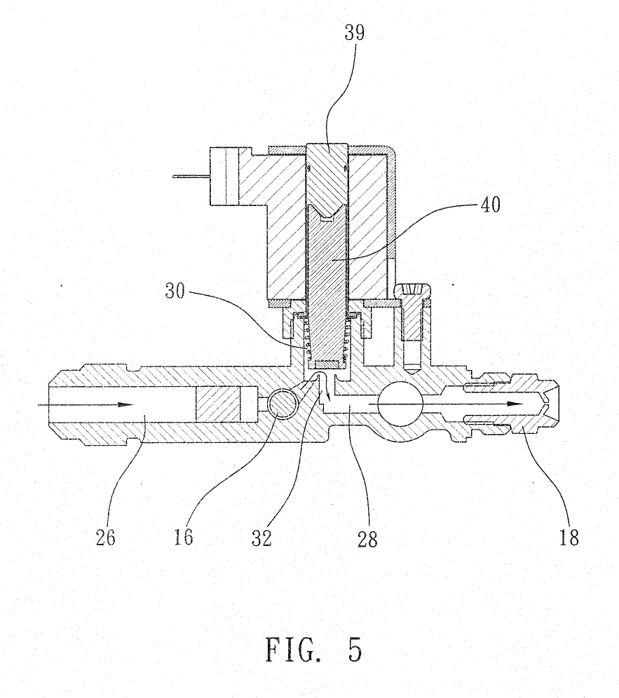

FIG. 5 and FIG. 6 are action views of the first preferred embodiment of the present invention; and

FIG. 7 and FIG. 8 are profile views of a second preferred embodiment of the present invention.

### DETAILED DESCRIPTION OF THE INVENTION

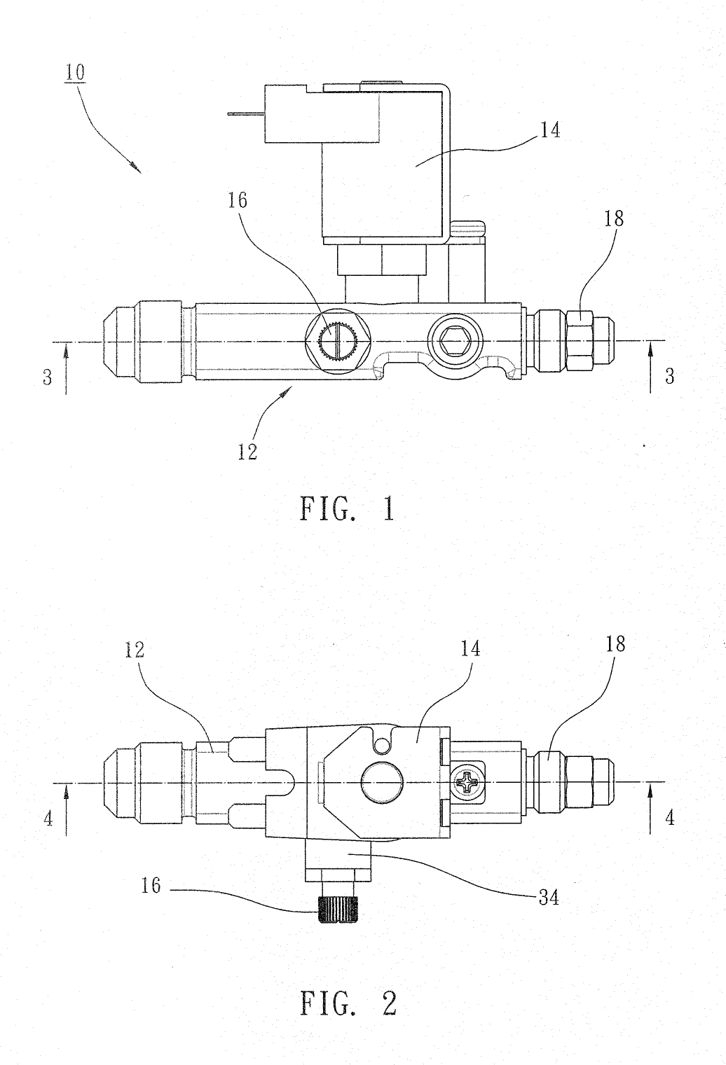

Firstly, referring to FIGS. 1˜4, the solenoid switch 10 of the preferred embodiment, consists of a valve body 12, a solenoid valve 14, a controller 16 and a nozzle 18.

The valve body 12 is provided with a tubular main body 22, and a valve seat 24 protruded from one side of the main body 22; the main body 22 is fitted with a gas inlet 26 and a gas outlet 28; the valve seat 24 is fitted with a valve chamber 30 connected with the gas inlet 26 and gas outlet 28; moreover, a first pipe orifice 32 is arranged on the location of the gas outlet 28 connected with the valve chamber 30; a second pipe orifice 33 is arranged onto one end of the gas inlet 26 connected with the valve chamber 30; a hollow holding seat 34, arranged laterally on the main body 22 and connected with the gas inlet 26; it is fitted with a chamber 35 with screwed inner wall; a holding port 36, arranged laterally on the main body 22 and connected with the gas outlet 28; a cover 38, used to seal the holding port 36.

The solenoid valve 14, arranged on the valve chamber 30 correspondingly with the first pipe orifice 32, is a conventional solenoid valve for gas switch; it comprises magnetic absorber 39, an actuating axle 40 and an elastic member 41; of which the actuating axle 40 is used to control if the gas outlet 28 is connected with the valve chamber 30. Namely, when the solenoid valve 14 is not energized, the actuating axle 40 under the tension of elastic member 41 allows to seal the first pipe orifice 32, such that the gas outlet 28 cannot be connected with the valve chamber 30; when the solenoid valve 14 is energized, the magnetic absorber 39 could magnetically absorb the actuating axle 40, such that the actuating axle 40 no longer seals the first pipe orifice 32, and the gas outlet 28 is connected with the valve chamber 30.

The controller 16, screwed in the chamber 35 and extended into the gas inlet 26 in an axially rotating state; it consists of a rod 42 and a sealing ring 44; the rod 42 is provided with a rod body 46, a driving end 48 and a controlling end 50 at both ends of the rod body 46, a screwing portion 52, set on the rod body 46 and screwed onto inner wall of the chamber 35; the sealing ring 44 is sleeved onto the rod body 46, and the controlling end 50 is aligned with the second pipe orifice 33. The controller 16 can be manually rotated or shifted, such that the controlling end 50 could seal the second pipe orifice 33 to control gas flow into the valve chamber 30 from the gas inlet 26.

The nozzle 18, used for conventional gas switch, is arranged at one end of the gas outlet 28, allowing to spray gas from the gas outlet 28.

Based on this design, the solenoid switch 10 of the present invention could be used as the controller of gas refrigerator, etc, with its operating mode, characteristics and efficacies below:

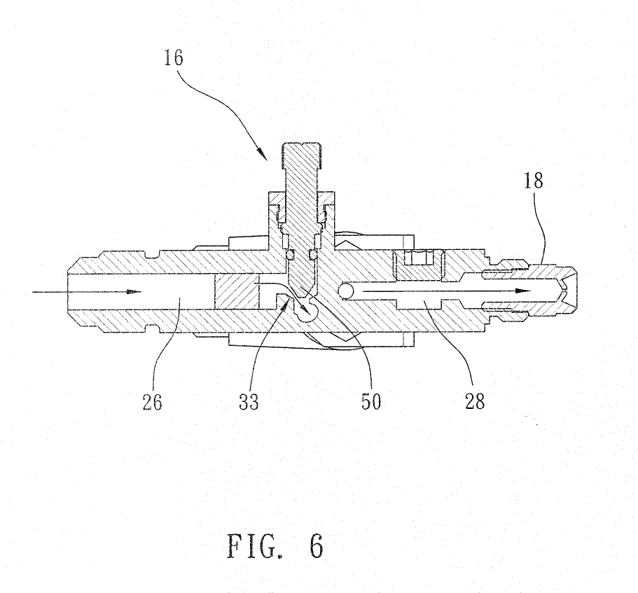

Referring to FIGS. 5 and 6, when the solenoid valve 14 is energized, the actuating axle 40 no longer seals the first pipe orifice 32 under the action of magnetic absorber 39, so the gas outlet 28 is connected with the valve chamber 30; in such case, the controller 16 is rotated to shift upwards, such that the controlling end 50 no longer seals the second pipe orifice 33, and gas flows into the valve chamber 30 via the gas inlet 26 and then into the gas outlet 28 from the valve chamber 30 for spraying from the nozzle 18. Otherwise, if the controller 16 is rotated again, the controller 16 may shift downwards to seal the second pipe orifice 33, such that the gas inlet 26 is blocked, and gas will not flow into the valve chamber 30. Hence, no gas is output to the gas outlet 28 even if the solenoid valve 14 is actuated.

When the solenoid valve 14 is not energized, the magnetic absorber 39 loses its magnetism, so the actuating axle 40 under the tension of the elastic member 41 will seal the first pipe orifice 32, and the valve chamber 30 cannot be connected with the gas outlet 28; in such case, no gas flows from the valve chamber 30 into gas outlet 28 for combustion, even if the controller 16 is shifted to the place where the second pipe orifice 33 is not sealed.

In other words, the solenoid valve 14 is used to control if the valve chamber 30 is connected with the gas outlet 28, while the controller 16 is used to control if the gas inlet 26 is connected with the valve chamber 30; with the collaboration of the solenoid valve 14 and controller 1, the spraying combustion of gas from the valve body 12 can be controlled efficiently.

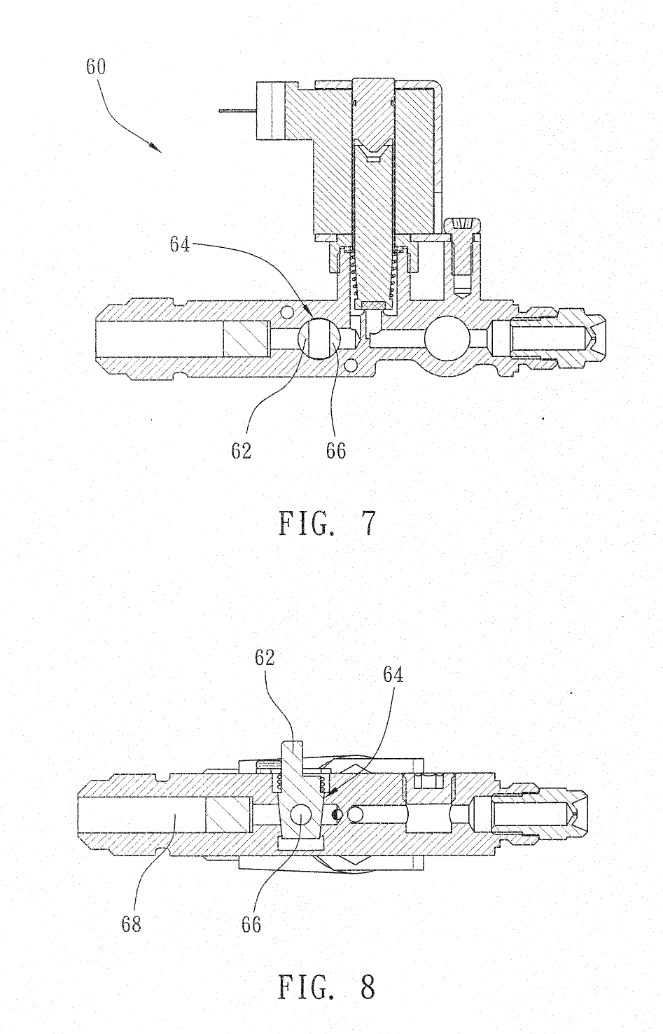

Referring to FIGS. 7 and 8, another preferred embodiment of the solenoid switch 60 is difference with the solenoid switch 10 lies in that: the tapered profiles of the controller 62 and chamber 64 are mated each other; so the controller 62 can be rotary arranged on the chamber 64, where a through-hole 66 is set correspondingly with the gas inlet 68. As the solenoid valve 70 of the solenoid switch 60 is operated in the same way with that of said solenoid valve 14, when the controller 62 is rotated, the gas inlet 68 can be switched on or blocked off by the through-hole 66, so as to control if gas flows into the valve chamber 72.

It is thus learnt that, the solenoid switch of the present invention features simple construction, and the solenoid valve and the controller are arranged separately onto the valve body, making it easier for assembly to meet the gas control requirements of gas refrigerator's combustor; so the following claims are made hereunder.

What is claimed is:

1. A solenoid switch, comprising:
a valve body, consisting of: a valve chamber and a gas inlet/outlet connected with the valve chamber; a first pipe orifice is arranged on the location of the gas outlet connected with the valve chamber;
a solenoid valve, arranged on the valve chamber correspondingly with the first pipe orifice, and used to control if the gas outlet is connected with the valve chamber; and
a controller, arranged in the valve body and extended into the gas inlet, and manually operated to control if gas flows from gas inlet into valve chamber; and a nozzle, arranged at one end of the gas outlet.

2. The solenoid switch as defined in claim 1, wherein the valve body consists of a tubular main body and a valve seat protruded from one side of the main body; the main body is fitted with a gas inlet and a gas outlet; the valve chamber is assembled into the valve seat, and the solenoid valve is arranged onto the valve seat.

3. The solenoid switch as defined in claim 1, wherein the valve body is fitted with a chamber connected with the gas inlet, and the controller is arranged in the chamber.

4. The solenoid switch as defined in claim 3, wherein the controller can be movably assembled into the chamber in relation to the gas inlet.

5. The solenoid switch as defined in claim 4, wherein a second pipe orifice is arranged at one end of the gas inlet connected with the valve chamber; one end of the controller is aligned with the second pipe orifice, and used to seal the second pipe orifice and control if the gas inlet is connected with the valve chamber.

6. The solenoid switch as defined in claim 5, wherein said controller consists of a rod and a sealing ring; of which the rod is provided with a rod body, a driving end and a controlling end at both ends of the rod body; the controlling end is aligned with the second pipe orifice, and the sealing ring is sleeved onto the rod body and abutted onto inner wall of the chamber.

7. The solenoid switch as defined in claim 3, wherein said controller can be rotary arranged on the chamber, where a through-hole is set correspondingly with the gas inlet.

8. The solenoid switch as defined in claim 7, wherein the tapered profiles of the controller and chamber are mated each other.

9. The solenoid switch as defined in claim 1, wherein the valve body is fitted with a holding port connected with the gas outlet, and a cover to seal the holding port.
